(19) United States
(12) Patent Application Publication
(10) Pub. No.: US 2012/0011265 A1
(43) Pub. Date: Jan. 12, 2012

(54) METHOD AND APPARATUS FOR CALCULATING A PROBABLE THROUGHPUT FOR A LOCATION BASED AT LEAST IN PART ON A RECEIVED THROUGHPUT

(75) Inventors: Igor Danilo Diego Curcio, Tampere (FI); Kalervo Mikael Kontola, Tampere (FI); Miska Matias Hannuksela, Ruutana (FI); Vinod Malamal-Vadakital, Tampere (FI)

(73) Assignee: Nokia Corporation, Espoo (FI)

(21) Appl. No.: 12/833,848

(22) Filed: Jul. 9, 2010

(51) Int. Cl. G06F 15/16

(52) U.S. Cl. 709/231

(57) ABSTRACT

An apparatus for calculating a probable throughput for a location may include a compiler for organizing a received throughput corresponding to a recorded throughput and a location indicator stored in a memory device. The calculation of the probable throughput may be conducted by a probable throughput calculator. The stream rate may thus be adapted by a stream rate adaptor in response to the probable throughput at the location to thereby create a buffer of sufficient size to continue rendering the content at the location. For example, the stream rate may be adapted to a maximum throughput value which is determined by a maximum throughput determiner.

### TECHNOLOGICAL FIELD

Embodiments of the present invention relate generally to calculating a probable throughput and, more particularly, relate to an apparatus, method and a computer program product for calculating a probable throughput for a location based at least in part on a received throughput.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and less expensive to obtain. Due to the now ubiquitous nature of mobile terminals, people of all ages and education levels are utilizing mobile terminals to communicate with other individuals or contacts, receive services and/or share information, media and other content.

Uses of mobile terminals which are becoming more popular include that of streaming and progressively downloading content such as movies and audio. Using these techniques, the user may receive the content and begin viewing or listening to the content without having to wait for the content to fully download. However, issues may arise in instances in which network coverage is insufficient to provide the data throughput necessary to continuously stream the content. When the throughput is insufficient, the rendering of the content may be temporarily stopped, reduced in rendered quality, and/or error prone. One currently implemented solution to this problem is that of storing a buffer for the content which may allow the mobile terminal to continue rendering the content even when the throughput of the data stream of the content is insufficient to support continuous rendering of the content. However, use of a buffer may not be sufficient in all instances without storing a relatively large buffer. Further, storing a relatively large buffer may place unnecessary burdens on the user terminal and/or the network streaming the content when the throughput is sufficient to continuously render the content.

### BRIEF SUMMARY

A method, apparatus and computer program product are therefore provided that may facilitate streaming of content by calculating a probable throughput for a location. The calculation of the probable throughput may be based at least in part on a received throughput and may be utilized to provide for streaming without requiring an unnecessarily large buffer.

In an example embodiment, an apparatus comprises at least one processor and at least one memory including computer program code, the at least one memory and the computer program code configured to, with the processor, cause the apparatus to provide for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput value received in the location, provide for storing a location indicator corresponding to the location of data streaming reception, wherein the parameters are coupled to the location, and calculate a probable throughput for the location based at least in part on one or more of the parameters, wherein the probable throughput is stored and coupled to the location.

In an additional example embodiment, a method comprises providing for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput value received in the location, providing for storing a location indicator corresponding to the location of data streaming reception, wherein the parameters are coupled to the location, and calculating a probable throughput for the location via a processor based at least in part on one or more of the parameters, wherein the probable throughput is stored and coupled to the location.

In a further example embodiment a computer program product comprises at least one computer-readable storage medium having computer-executable program code portions stored therein, the computer-executable program code portions comprising program code instructions providing for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput value received in the location, program code instructions providing for storing a location indicator corresponding to the location of data streaming reception, wherein the parameters are coupled to the location, and program code instructions for calculating a probable throughput for the location based at least in part on one or more of the parameters, wherein the probable throughput is stored and coupled to the location.

In another example embodiment an apparatus comprises at least one processor and at least one memory including computer program code, the at least one memory and the computer program code configured to, with the processor, cause the apparatus to receive a data stream at a location, provide for transmission of at least one of a location indicator corresponding to the location, a sampling time indicative of a time instance at which the received throughput was measured, a radio signal level, a network operator code, a network type indicator, a received throughput, a content provider characteristic, and a communication protocol indicator, and receive at least one of a probable throughput, a probing flag indicative of whether the apparatus probed for a maximum bitrate, and a maximum throughput value received in the location.

In an additional example embodiment a method comprises receiving a data stream at a location, providing for transmission via a processor of at least one of a location indicator corresponding to the location, a sampling time indicative of a time instance at which the received throughput was measured, a radio signal level, a network operator code, a network type indicator, a received throughput, a content provider characteristic, and a communication protocol indicator, and receiving at least one of a probable throughput, a probing flag indicative of whether the apparatus probed for a maximum bitrate, and a maximum throughput value received in the location.

In a further example embodiment a computer program product comprises at least one computer-readable storage medium having computer-executable program code portions stored therein, the computer-executable program code portions comprising program code instructions for receiving a data stream at a location, program code instructions providing for transmission of at least one of a location indicator corresponding to the location, a sampling time indicative of a time instance at which the received throughput was measured, a radio signal level, a network operator code, a network type indicator, a received throughput, a content provider characteristic, and a communication protocol indicator, and program code instructions for receiving at least one of a probable throughput, a probing flag indicative of whether the apparatus probed for a maximum bitrate, and a maximum throughput value received in the location.

In another example embodiment an apparatus comprises means for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput indicative of the maximum throughput value received in the location, means for storing a location indicator corresponding to the location of data streaming reception, wherein the parameters are coupled to the location, and means for calculating a probable throughput for the location based at least in part on one or more of the parameters, wherein the probable throughput is stored and coupled to the location.

In a further example embodiment, an apparatus comprises means for receiving a data stream at a location, means for transmitting at least one of a location indicator corresponding to the location, a sampling time indicative of a time instance at which the received throughput was measured, a radio signal level, a network operator code, a network type indicator, a received throughput, a content provider characteristic, and a communication protocol indicator, and means for receiving at least one of a probable throughput, a probing flag indicative of whether the apparatus probed for a maximum bitrate, and a maximum throughput value received in the location.

Accordingly, embodiments of the present invention may calculate a probable throughput for a location based at least in part on a received throughput, thereby facilitating, for example, streaming of content.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus for calculating a probable throughput for a location based at least in part on a received throughput according to an example embodiment of the present invention; and

FIG. 3 illustrates a flowchart according to an example method for calculating a probable throughput for a location based at least in part on a received throughput in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

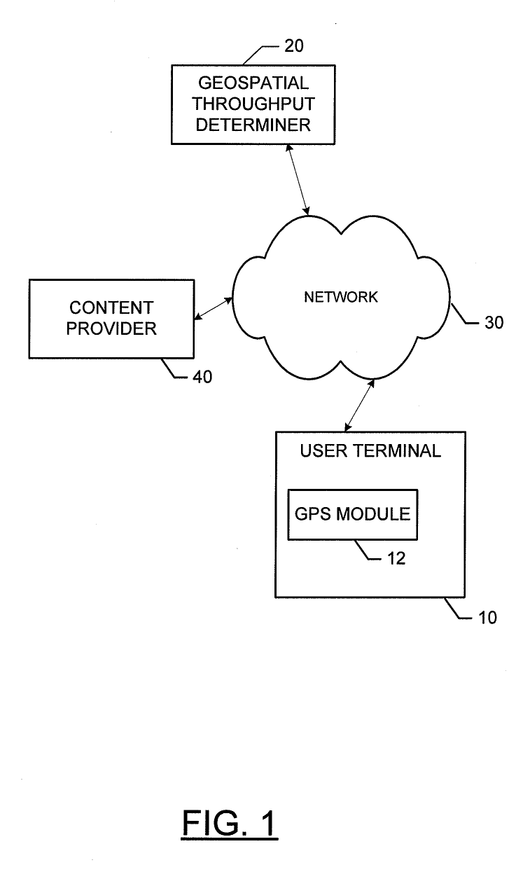

As indicated above, embodiments of the present invention may be employed in methods, apparatuses and computer program products providing for output of a new content segment based on an association structure. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention.

The user terminal 10 may be configured to receive and display content received via data streams which may be streamed or progressively downloaded. The user terminal 10 may include a GPS module 12 or other module which allows the user terminal to calculate its location. In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal 10 and/or the other devices may be enabled to communicate with each other, for example, according to numerous communication protocols including Hypertext Transfer Protocol (HTTP) and/or the like, to thereby carry out various communication or other functions of the mobile terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The system may further comprise a content provider 40 which may be in communication with the user terminal 10 either directly, or through the network 30. The content provider 40 may be configured to provide content such as movies, audio, etcetera to the user terminal 10. In some embodiments the content provider 40 may be a server, server bank or other computer or other computing device or node configured to provide content. The content provider 40 may have any number of functions or associations with various services. As such, for example, the content provider 40 may be a platform such as a dedicated server (or server bank), or the content provider may be a backend server associated with one or more other functions or services. Thus, the content provider 40 may potentially provide a variety of different content segments. In some embodiments the content provider 40 may select and distribute commercial and/or non-commercial content. Accordingly, the operations performed by the content provider 40 may or may not comprise processing payment in exchange for distributing the content segments. In some embodiments payment may be processed by a separate device.

The system may further comprise a geospatial throughput determiner 20. The geospatial throughput determiner 20 may be configured to receive and store data relating to the throughput which occurs at various physical locations through the network when data streams are transmitted to devices such as the user terminal 10. As will be described in detail below, the geospatial throughput determiner 20 may thereby calculate a probable throughput for a given location based at least in part on one or more received throughputs which previously occurred, and/or previously recorded radio signal levels. For purposes of brevity, the calculation of probable throughput will herein be described generally as being based on received throughputs. However, as indicated above, the calculation of the probable throughput may alternatively or additionally be based on recorded radio signal levels in some embodiments. The received throughputs and location indicators may be provided by devices, such as the user terminal 10, constantly, or in batches which are sent in intervals in order to reduce the burden on the network 30. As will be further described below, the geospatial throughput determiner 20 may thereby be used to adapt the stream rate in response to the probable throughput at a location. For example, if it is known that the user terminal 10 will be traveling to a location with a low probable throughput, as calculated by the geospatial throughput determiner 20, this information may thereby be used to adapt the stream rate in response to the probable throughput at the location. By way of further example, the stream rate may be adapted to a maximum throughput value.

In some embodiments the geospatial throughput determiner 20 may comprise a portion of, or otherwise be embodied in, one or both of the content provider 40 and the user terminal 10. In other embodiments the geospatial throughput determiner 20 may be a separate server, server bank or other computer or other computing device or node configured to compile a geospatial throughput determiner. The geospatial throughput determiner 20 may have any number of functions or associations with various services. As such, for example, the geospatial throughput determiner 20 may be a platform such as a dedicated server (or server bank), or the geospatial throughput determiner may be a backend server associated with one or more other functions or services.

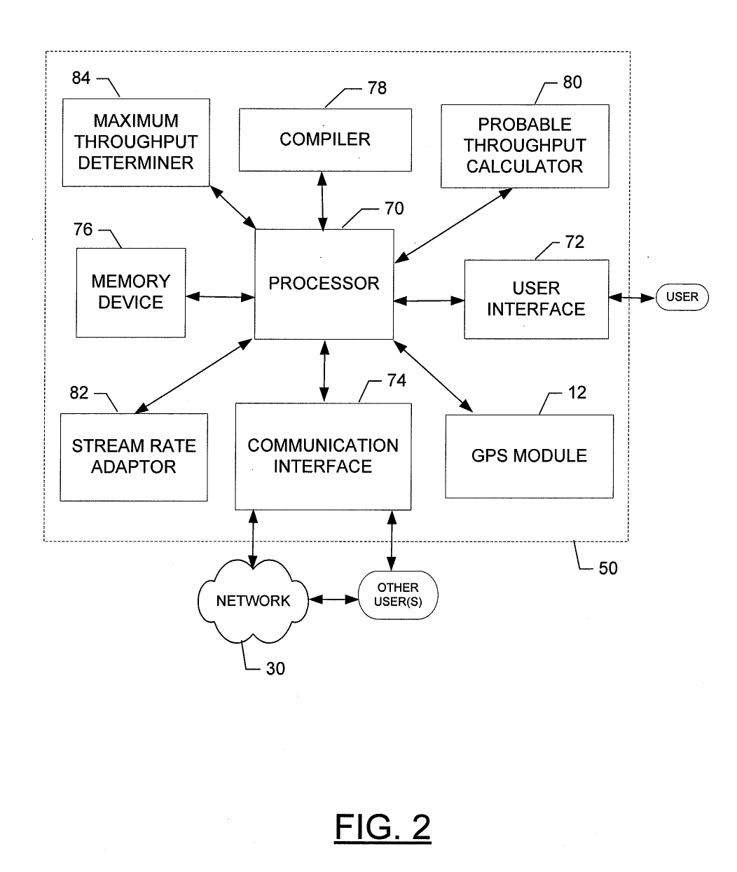

In an example embodiment, an apparatus 50 is provided that may be employed by devices performing example embodiments of the present invention. The apparatus 50 may be embodied, for example, as any device hosting, including, controlling or otherwise comprising the geospatial throughput determiner 20. However, embodiments of the apparatus 50 may also be embodied on a plurality of other devices such as for example where instances of the apparatus may be embodied on the network 30, the user terminal 10, and/or the content provider 40. As such, the apparatus 50 of FIG. 2 is merely an example and may include more, or in some cases less, than the components shown in FIG. 2.

With further regard to FIG. 2, the apparatus 50 is configured to calculate a probable throughput for a location based at least in part on a received throughput. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

In some embodiments the apparatus 50 may be configured to store a received throughput for a data stream. For example, the received throughput may be received through the communication interface 74 and stored in the memory device 76. Thus, by way of further example, the received throughput may be received from a device such as the user terminal 10 through the network 30. A received throughput may in some embodiments comprise an actual received throughput which is recorded, for example when the content provider 40 transmits a data stream to the user terminal 10 through the network 30. Thus in some embodiments the received throughput may be recorded, for example, in kilobits per second. In other embodiments the apparatus 50 may additionally or alternatively store a radio signal level which indicates the strength of the signal, for example, received by the user terminal 10, and which may, for example, be measured in decibels or scaled to within a predefined range. In this embodiment, the radio signal level provides an indication of the actual throughput that could be supported.

The apparatus 50 may also be configured to store a location indicator corresponding to a location at which the data stream was received. For example, the user terminal 10 may employ the GPS module 12 to calculate the position of the user terminal at the sampling time at which the received throughput and/or other information regarding a data stream was recorded. However, in other embodiments various alternate or additional methods of determining location may be employed, for example triangulation using cell phone towers. Once the location indicator, which may comprise a set of coordinates, is determined, it may be transmitted to the apparatus 50. However, as described above, in some embodiments the apparatus 50 may be embodied in the user terminal 10. Accordingly, in such embodiments the apparatus 50 may comprise the GPS module 12, as illustrated.

Regardless of whether the apparatus 50 receives or internally determines the location indicator, the apparatus may store the location indicator. Thus, the apparatus 50 may thereby compile the received throughput and the location indicator into an organized database, which may be stored in the memory device 76, or an external database in some embodiments. In this regard, the received throughput may be associated with or otherwise linked to the corresponding location indicator, that is, the location indicator representative of the location for which the received throughput was determined. The organizing of the data into a database may be conducted by a compiler 78. The processor 70 may be embodied as, include or otherwise control the compiler 78. The compiler 78 may organize a variety of pieces of data, which may in some embodiments be sorted based on the location indicators. Thus, for example, a variety of data may be stored in association with each location for which the database includes a location indicator. In this regard, the compiler 78 may determine that location indicators which correspond to locations within a predefined distance of one another, are substantially close to one another. Thereby, the compiler 78 may determine that the location indicators within the predefined distance threshold correspond to the same location and the compiler may thereby organize the data on this basis. In some embodiments the compiler 78 may also remove old data as new data comes in, for example on a first-in-first-out (FIFO) basis. For example, the compiler 78 may be configured to store a predetermined number of instances for each piece of stored data, and/or the compiler could be configured to store the data only for a predetermined period of time.

The apparatus 50 may further comprise a probable throughput calculator 80. The processor 70 may be embodied as, include or otherwise control the probable throughput calculator 80. The probable throughput calculator 80 may calculate a probable throughput for a location based at least in part on the received throughput. Thus, for example, the database may comprise data received from a variety of devices including the user terminal 10. The probable throughput calculator 80 may thereby use the various location indicators which are based on past data streaming events at the location to determine a probable throughput for the location. For example, the probable throughput calculator 80 may calculate a probable throughput based on a weighted average using the received throughputs.

However, one problem associated with calculating a probable throughput for a location is that the received throughputs which have previously been recorded may not necessarily be representative of future throughputs at that location. For example, networks may at some point be upgraded, and therefore older received throughputs may not accurately represent current conditions. Accordingly, in some embodiments the apparatus 50 may also store the sampling time which may be indicative of a time instance at which the received throughput was measured by a client device such as the user terminal 10. Thereby the probable throughput calculator 80 may give less weight to older received throughputs, ignore them completely, or delete them such as by using the FIFO system described above. The sampling time may, for example, be recorded and transmitted by the user terminal 10 to the apparatus 50. Accordingly, the probable throughput calculator 80 may update the probable throughput such that it more accurately represents present conditions.

Further, the probable throughput for a location may depend on the network on which a device is operating. Thus, the apparatus 50 may additionally store a network indicator in the database in association with the location indicator and received throughput. The network indicator may indicate the network operator code of the network provider on which the user terminal 10 is operating at the sampling time. The network indicator may additionally or alternatively include a network type indicator corresponding to the network type on which the device is operating at the sampling time. For example, the network type indicator may indicate whether the device is operating on a 3G network. The characteristics of the network may be important because the probable throughput may vary depending on the network provider and the network type. Accordingly, using the network indicator, which may for example be transmitted by the user terminal 10 to the apparatus 50, the probable throughput calculator 80 may be able to more accurately calculate the probable throughput for each location. For example, the probable throughput at each location may be calculated for each network type and each network operator code in some embodiments.

The apparatus 50 may additionally store a content provider characteristic in the database in association with the location indicator and the received throughput. The content provider characteristic may include an indicator of a streaming server such as one or more of the Internet Protocol (IP) address of the server or other information indicative of the geographical location of the server. In one embodiment the content provider 40 may transmit the content provider characteristic to the apparatus 50. This information may be used by the probable throughput calculator 80 to determine how likely it is that the location of the content provider 40 affected the received throughput. For instance, if the content provider 40 is very far away from the device receiving the data stream, for example the user terminal 10, this might lead to the throughput in this instance being less than it may otherwise be expected. Accordingly, the probable throughput calculator 80 may impart less weight to received throughputs which have a corresponding content provider characteristic indicating that the content provider 40 is far away, for example greater than a predetermined distance from the device receiving the data stream. Similarly, the apparatus 50 may also store a communication protocol indicator which indicates the communication protocol stack, for example (Hypertext Transfer Protocol/Transmission Control Protocol/Internet Protocol (HTTP/TCP/IP) or Real-Time Transfer Protocol/User Datagram Protocol/Internet Protocol (RTP/UDP/IP), that was in use at the sampling time. The communication protocol indicator may, for example, be transmitted from the content provider 40 to the apparatus 50. The probable throughput calculator 80 may use the communication protocol indicator to determine the impact of the flow control of the protocol for the protocol stack to the throughput, and thereby adjust the weight imparted to the received throughputs accordingly when calculating the probable throughput.

The apparatus 50 may further comprise a stream rate adaptor 82 which is configured to adapt a stream rate in response to the probable throughput at the location. The processor 70 may be embodied as, include or otherwise control the stream rate adaptor 82. Adapting the stream rate may be useful, for example, when the user terminal 10 predicts that it is going to be traveling through a certain location. For example, the user terminal 10 may be operating in a navigation mode which directs the user to travel through the location. The apparatus 50 may thereby determine the probable throughput for that location as described above. In some instances the probable throughput at that location may be insufficient to continue rendering content which is being transmitted to the user terminal 10 from the content provider 40 through a data stream. Accordingly, the stream rate adaptor 82 may attempt to increase the stream rate to the user terminal 10 prior to entering the certain location of relatively poor throughput to increase the amount of data buffered in the user terminal such that the user terminal may continue seamlessly rendering the content while passing through the certain location even though the streaming is insufficient to fully support seamless rendering while in the certain location. Further, in some embodiments the content provider characteristic may additionally or alternatively comprise information relating to the bit rate adaptation characteristics of the content provider 40. For example, in some embodiments the content provider 40 may support Third Generation Partnership Project (3GPP) Packet Switch System (PSS) adaptation signaling. Thus, the content provider characteristic may comprise this and other information, such as the server manufacturer, name, and version which may allow the stream rate adaptor 82 to determine the stream rate adaptation capabilities of the content provider 40, and thereby provide for the desired adaptation of the stream rate. For example, the stream rate adaptor 82 could use the communication interface 74 to transmit the probable throughput to the user terminal and/or tell the user terminal to request a higher stream rate from the content provider 40.

In some embodiments the apparatus 50 may also store information relating to whether or not the received throughputs correspond with a maximum throughput value received in the location. For example, the user terminal 10 may not in all instances require the maximum throughput value to stream content. Accordingly, the received throughput may not in all instances correspond to the maximum throughput value which is possible at that location. Thus, the probable throughput may not necessarily correspond with the maximum possible throughput at the location. Therefore, in some embodiments the apparatus 50 may comprise a maximum throughput determiner 84 which stores a probing flag, which may comprise a Boolean value, for each received throughput which may be indicative of whether or not the user terminal 10 probed for a maximum bitrate for the location at the sampling time. The processor 70 may be embodied as, include or otherwise control the maximum throughput determiner 84. The maximum throughput determiner 84 may determine that the user terminal 10 is seeking the maximum throughput value when, for example, a throughput request is rejected for being too high. Alternatively, the maximum throughput determiner 84 may compare the received throughput to the limits of the network 30 on which the user terminal 10 is operating based on the network indicator as described above. The stream rate adaptor 82 may also use information relating to the maximum throughput value, as determined by the maximum throughput determiner 84, to adapt the throughput to the maximum throughput value in some embodiments. Thus, for example, the apparatus 50 may send to the user terminal 10 a signal indicating to the user terminal 10 to request a higher throughput, the probing flag, and/or the maximum throughput value. Thereby, when necessary, the user terminal 10 may use the maximum throughput to buffer the content prior to reaching a location where the probable throughput will be insufficient.

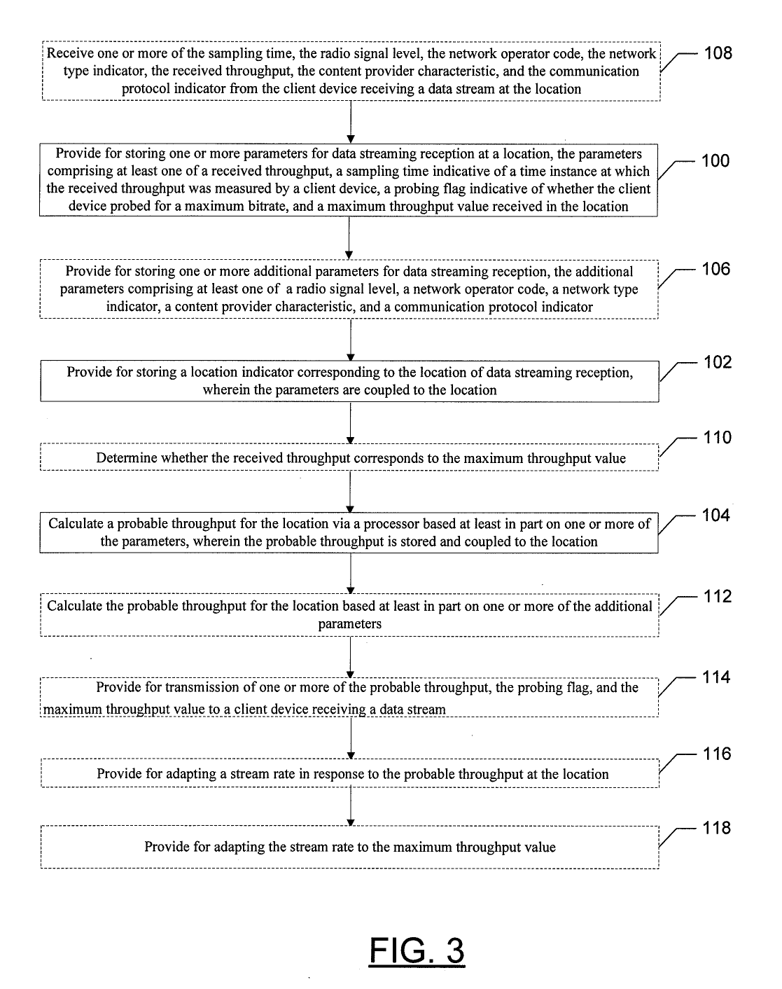

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method comprises providing for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput value received in the location at operation 100. The method may further comprise providing for storing a location indicator corresponding to the location of data streaming reception, wherein the parameters are coupled to the location at operation 102. Thereby, the method may additionally comprise calculating a probable throughput for the location via a processor based at least in part on one or more of the parameters, wherein the probable throughput is stored and coupled to the location at operation 104.

In some embodiments, certain ones of the above-described operations (as illustrated in solid lines in FIG. 3) may be modified or further amplified. In some embodiments additional operations may also be included (some examples of which are shown in dashed lines in FIG. 3). It should be appreciated that each of the modifications, optional additions or amplifications may be included with the above-described operations (100-104) either alone or in combination with any others among the features described herein. As such, each of the other operations as will be described herein may be combinable with the above-described operations (100-104) either alone or with one, more than one, or all of the additional operations in any combination.

For example, the method may further comprise providing for storing one or more additional parameters for data streaming reception, the additional parameters comprising at least one of a radio signal level, a network operator code, a network type indicator, a content provider characteristic, and a communication protocol indicator at operation 106. Therefore, the method may additionally comprise receiving one or more of the sampling time, the radio signal level, the network operator code, the network type indicator, the received throughput, the content provider characteristic, and the communication protocol indicator from the client device receiving a data stream at the location at operation 108. In some embodiments the content provider characteristic may comprise an indicator of a streaming server. Also, the method may comprise determining whether the received throughput corresponds to the maximum throughput value at operation 110. Further, the method may comprise calculating the probable throughput for the location based at least in part on one or more of the additional parameters at operation 112. The method may additionally comprise providing for transmission of one or more of the probable throughput, the probing flag, and the maximum throughput value to a client device receiving a data stream at operation 114. The method may also comprise providing for adapting a stream rate in response to the probable throughput at the location at operation 116. Thus, the method may also comprise providing for adapting the stream rate to the maximum throughput value at operation 118.

In an example embodiment, an apparatus for performing the method of FIG. 3 and other methods described above may comprise a processor (for example, the processor 70) configured to perform some or each of the operations (100-118) described above. The processor may, for example, be configured to perform the operations (100-118) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-118 may comprise, for example, the processor 70, the communication interface 74, the memory device 76, the compiler 78, the GPS module 12, the probable throughput calculator 80, the stream rate adaptor 82, and the maximum throughput determiner 84, and/or an algorithm executed by the processor for processing information as described above. However, the above-described portions of the apparatus 50 as they relate to the operations of the method illustrated in FIG. 3 are merely examples, and it should be understood that various other embodiments may be possible.

In some embodiments the operation 100 of storing the parameters stream may be conducted by means for storing one or more parameters, such as the memory device 76 and/or the processor 70. Further, storing a location indicator at operation 102 may be conducted by means for storing a location indicator, such as the memory device 76 and/or the processor 70. Further, in embodiments in which the apparatus 50 is embodied in the user terminal 10, means, such as the GPS module 12, may be employed to determine the location. Further, the operation 104 of calculating a probable throughput may be conducted by means for calculating a probable throughput, such as the probable throughput calculator 80 and/or the processor 70.

Further, the operation 106 of storing one or more additional parameters may be conducted by means, such as the memory device 76 and/or the processor 70. Also, the operation 108 of receiving may be conducted by means, such as the communication interface 74 and/or the processor 70. Additionally, the operation 110 of determining whether the received throughput corresponds to the maximum throughput value may be conducted by means, such as the maximum throughput determiner 84.

Further, the operation 112 of calculating the probable throughput for the location based at least in part on one or more of the additional parameters may be conducted by means, such as the probable throughput calculator 80 and/or the processor 70. Additionally, the operation 114 of providing for transmission may be conducted by means, such as the communication interface 74, and/or the processor 70. Also, the operation 116 of providing for adapting a stream rate may be conducted by means, such as the stream rate adaptor 82, and/or the processor 70. Further, the operation 118 of providing for adapting the stream rate to the maximum throughput valve may be conducted by means, such as the stream rate adaptor 82, the maximum throughput determiner 84, and/or the processor 70.

An additional method which may relate to a client perspective, as opposed to a server perspective as may be embodied above, may conversely comprise receiving a data stream at a location, providing for transmission via a processor of at least one of a location indicator corresponding to the location, a sampling time indicative of a time instance at which the received throughput was measured, a radio signal level, a network operator code, a network type indicator, a received throughput, a content provider characteristic, and a communication protocol indicator, and receiving at least one of a probable throughput, a probing flag indicative of whether the apparatus probed for a maximum bitrate, and a maximum throughput value received in the location. In this regard, receiving a data stream may be conducted by means for receiving a data stream, such as the communication interface 74, and/or the processor 70. Additionally, transmitting may be conducted by means for transmitting, such as the communication interface 74, and/or the processor 70. Further, receiving at least one of a probable throughput, a probing flag indicative of whether the apparatus probed for a maximum bitrate, and a maximum throughput value received in the location may be conducted by means for receiving, such as the communication interface 74, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
provide for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput value received in the location;
provide for storing a location indicator corresponding to the location of data streaming reception, wherein the parameters are coupled to the location; and
calculate a probable throughput for the location based at least in part on one or more of the parameters, wherein the probable throughput is stored and coupled to the location.

2. The apparatus of claim 1, further configured to provide for storing one or more additional parameters for data streaming reception, the additional parameters comprising at least one of a radio signal level, a network operator code, a network type indicator, a content provider characteristic, and a communication protocol indicator; and
calculate the probable throughput for the location based at least in part on one or more of the additional parameters.

3. The apparatus of claim 2, wherein the content provider characteristic comprises an indicator of a streaming server.

4. The apparatus of claim 2, further configured to receive one or more of the sampling time, the radio signal level, the network operator code, the network type indicator, the received throughput, the content provider characteristic, and the communication protocol indicator from the client device receiving a data stream at the location.

5. The apparatus of claim 1, further configured to provide for transmission of one or more of the probable throughput, the probing flag, and the maximum throughput value to a client device receiving a data stream.

6. The apparatus of claim 1, further configured to determine whether the received throughput corresponds to the maximum throughput value.

7. The apparatus of claim 1, further configured to provide for adapting a stream rate in response to the probable throughput at the location.

8. The apparatus of claim 7, further configured to provide for adapting the stream rate to the maximum throughput value.

9. A method comprising:
providing for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput value received in the location;
providing for storing a location indicator corresponding to the location of data streaming reception, wherein the parameters are coupled to the location; and
calculating a probable throughput for the location via a processor based at least in part on one or more of the parameters, wherein the probable throughput is stored and coupled to the location.

10. The method of claim 9, further comprising providing for storing one or more additional parameters for data streaming reception, the additional parameters comprising at least one of a radio signal level, a network operator code, a network type indicator, a content provider characteristic, and a communication protocol indicator; and
calculating the probable throughput for the location based at least in part on one or more of the additional parameters.

11. The method of claim 10, wherein the content provider characteristic comprises an indicator of a streaming server.

12. The method of claim 10, further comprising receiving one or more of the sampling time, the radio signal level, the network operator code, the network type indicator, the received throughput, the content provider characteristic, and the communication protocol indicator from the client device receiving a data stream at the location.

13. The method of claim 9, further comprising providing for transmission of one or more of the probable throughput, the probing flag, and the maximum throughput value to a client device receiving a data stream.

14. The method of claim 9, further comprising determining whether the received throughput corresponds to the maximum throughput value.

15. The method of claim 9, further comprising providing for adapting a stream rate in response to the probable throughput at the location.

16. The method of claim 15, further comprising providing for adapting the stream rate to the maximum throughput value.

17. A computer program product comprising at least one computer-readable storage medium having computer-executable program code portions stored therein, the computer-executable program code portions comprising:
program code instructions providing for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput value received in the location;
program code instructions providing for storing a location indicator corresponding to the location of data streaming reception, wherein the parameters are coupled to the location; and
program code instructions for calculating a probable throughput for the location based at least in part on one or more of the parameters, wherein the probable throughput is stored and coupled to the location.

18. An apparatus comprising at least one processor and at least one memory including computer program code, the at least one memory and the computer program code configured to, with the processor, cause the apparatus to:
receive a data stream at a location;
provide for transmission of at least one of a location indicator corresponding to the location, a sampling time indicative of a time instance at which the received throughput was measured, a radio signal level, a network operator code, a network type indicator, a received throughput, a content provider characteristic, and a communication protocol indicator; and
receive at least one of a probable throughput, a probing flag indicative of whether the apparatus probed for a maximum bitrate, and a maximum throughput value received in the location.

19. A method comprising:
receiving a data stream at a location;
providing for transmission via a processor of at least one of a location indicator corresponding to the location, a sampling time indicative of a time instance at which the received throughput was measured, a radio signal level, a network operator code, a network type indicator, a received throughput, a content provider characteristic, and a communication protocol indicator; and
receiving at least one of a probable throughput, a probing flag indicative of whether the apparatus probed for a maximum bitrate, and a maximum throughput value received in the location.

20. A computer program product comprising at least one computer-readable storage medium having computer-executable program code portions stored therein, the computer-executable program code portions comprising:
program code instructions for receiving a data stream at a location;
program code instructions providing for transmission of at least one of a location indicator corresponding to the location, a sampling time indicative of a time instance at which the received throughput was measured, a radio signal level, a network operator code, a network type indicator, a received throughput, a content provider characteristic, and a communication protocol indicator; and
program code instructions for receiving at least one of a probable throughput, a probing flag indicative of whether the apparatus probed for a maximum bitrate, and a maximum throughput value received in the location.

21. An apparatus comprising:
means for storing one or more parameters for data streaming reception at a location, the parameters comprising at least one of a received throughput, a sampling time indicative of a time instance at which the received throughput was measured by a client device, a probing flag indicative of whether the client device probed for a maximum bitrate, and a maximum throughput indicative of the maximum throughput value received in the location;
means for storing a location indicator corresponding to the location of data streaming reception, wherein the parameters are coupled to the location; and
means for calculating a probable throughput for the location based at least in part on one or more of the parameters, wherein the probable throughput is stored and coupled to the location.

22. An apparatus comprising:
means for receiving a data stream at a location;
means for transmitting at least one of a location indicator corresponding to the location, a sampling time indicative of a time instance at which the received throughput was measured, a radio signal level, a network operator code, a network type indicator, a received throughput, a content provider characteristic, and a communication protocol indicator; and
means for receiving at least one of a probable throughput, a probing flag indicative of whether the apparatus probed for a maximum bitrate, and a maximum throughput value received in the location.
